(19) United States
(12) Patent Application Publication
(10) Pub. No.: US 2007/0116640 A1
(43) Pub. Date: May 24, 2007

(54) Titanium dioxide nanorod and preparation method thereof

(75) Inventors: Dong-Young Kim, Seoul (KR); Seong-Mu Jo, Seoul (KR); Byung-Doo Chin, Gyeonggi-do (KR); Jae-Pyoung Ahn, Seoul (KR); Mi-Yeon Song, Seoul (KR); Young-Rack Ahn, Seoul (KR)

Correspondence Address: DARBY & DARBY P.C., P. O. BOX 5257, NEW YORK, NY, 10150-5257, US

(73) Assignee: Korea Institute of Science and Technology, Seoul (KR)

(21) Appl. No.: 11/454,205

(22) Filed: Jun. 15, 2006

(30) Foreign Application Priority Data
Jun. 16, 2005 (KR) 52077/2005

(51) Int. Cl. C01G 23/047; D01D 5/30

(52) U.S. Cl. 423/610; 264/172.11; 264/11; 977/732; 977/932; 977/840; 136/263

(57) ABSTRACT

A titanium dioxide nanorod having anisotropy and a preparation method thereof in which, particularly, an ultrafine composite fiber of polymer and titanium dioxide precursor and a single crystal titanium dioxide nanorod using a phase separation are prepared, wherein a mixed solution containing titanium dioxide precursor, polymer which is compatible with the precursor and solvent is prepared, the mixed solution is electrospun to form titanium dioxide polymer composite fiber containing ultrafine fibril structure therein by the phase separation between the titanium dioxide precursor and the polymer, the composite fiber is heat-pressed, and the polymer material is removed from the composite fiber, so as to obtain titanium dioxide nanorod, which can be used as dye-sensitized solar cells, various sensors, and photocatalysts.

### BACKGROUND OF THE INVENTION

1. Field of the Invention

The present invention relates to titanium dioxide nanorods having anisotropy and a preparation method thereof, and particularly, to an ultrafine composite fiber obtained by using polymer and titanium dioxide precursor and a method for efficiently preparing a single crystal titanium dioxide nanorod using a phase separation.

2. Background of the Related Art

Titanium dioxide (TiO₂) has been commonly used in various fields for a long time, which can variously be applied to catalyst, photocatalyst, dye sensitized solar cells, pigments, gas sensors, cosmetics, and the like. In particular, the TiO₂ has characteristics such as high refractive index, transparency of visible ray zone, high electron affinity, and the like, so as to be actively applied as the photocatalyst for photolysis of water or organic matters. Also, the titanium dioxide can be expected to be used as an electrode material of the dye sensitized solar cells because of a large surface area of titanium dioxide nanoparticles and characteristics of a n-type semiconductor. Characteristics of the titanium dioxide nanoparticles may be affected by a shape of crystal, a size of particle, a structure of particle, or the like. In addition, the TiO2 has been developed in various shapes such as nanoparticle types, thin film types, porous particles, and the like. As a preparation method of titanium dioxide having a nanotube shape and titanium dioxide having a nanorod shape where are very interested in recent times, there have been well known wet methods such as a method in which a spherical nanoparticle is treated with a strong alkali to grow it as nanotube [U.S. Pat. No. 6,537,517], a method for growing nanoparticle within a micelle of surfactant [U.S. Pat. No. 6,855,202], and the like. In the methods, however, a number of times of washing and filtering are required in order to remove the strong alkali or surfactant having used and to thus Obtain titanium dioxide nanoparticles with high purity. Accordingly, processes for separating, washing and drying particles having nano sizes becomes complicated. Actually, in order to apply the titanium dioxide nanoparticle as a device, a large amount of pure particles should be obtained, however, the related art method may not be appropriate therefor.

Accordingly, a new method is required so as to simply fabricate a titanium dioxide anisotropic nanorod.

### BRIEF DESCRIPTION OF THE INVENTION

Therefore, an object of the present invention is to provide a method for easily preparing a large amount of titanium dioxide nanorod as compared to the related art method.

Another object of the present invention is to provide a method by which a nanorod can directly stably be formed on an electrode of an electric device.

Still another object of the present invention is to provide a titanium dioxide nanorod which has a uniform and large surface area and is capable of being used for dye sensitized solar cells, sensors, photocatalysts.

To achieve these and other advantages and in accordance with the purpose of the present invention, as embodied and broadly described herein, there is provided a method for preparing a titanium dioxide nanorod by providing ultrafine fibrous polymer and titanium dioxide precursor and performing an after-treatment therefor.

In detail, there is provided the method for preparing titanium dioxide nanorods in which a mixed solution containing titanium dioxide precursor, polymer compatible with the precursor and solvent is provided, the mixed solution is electrospun so as to form a titanium dioxide composite fiber accompanied with a phase separation between the titanium dioxide precursor and the polymer during electrospinning, the composite fiber is heat-pressed, and a polymer material is removed from the composite fiber to thus obtain a titanium dioxide nanorod.

The prepared titanium dioxide nanorod has a single crystalline structure, and can be used as photocatalyst as it is. Also, the titanium dioxide nanorod can be applied to dye sensitized solar cells, optical sensors, gas sensors, and the like by using metal plates, glass substrates having a transparent conductivity coated by ITO or FTO or plastic substrates, all the substrates or plates having a titanium dioxide nanorod aggregation formed thereon.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view showing an electrospinning apparatus applied to the present invention;

FIGS. 2a and 2b are scanning electron microscopic photographs of electrospun ultrafine titanium dioxide fibrous layer prepared using poly(vinyl acetate) in accordance with an embodiment of the present invention, wherein FIG. 2a shows an electrospun titanium dioxide-poly(vinyl acetate) composite fiber, and FIG. 2b shows a fibrous titanium dioxide from which poly(vinyl acetate) is removed after heat-treatment at 450° C.;

FIG. 3 is a scanning electron microscopic photograph of an electrospun ultrafine titanium dioxide fibrous layer which has been heat-pressed according to an embodiment of the present invention;

FIGS. 4a and 4b are scanning electron microscopic photographs of an electrospun ultrafine titanium dioxide fibrous layer which has been heat-presseed and calcinated at 450° C. in accordance with an embodiment of the present invention, wherein FIG. 4a shows a photo thereof at magnification of 20,000, and FIG. 4b shows a photo thereof at magnification of 100,000;

FIGS. 5a to 5c are transmission electron microscopic photographs of a titanium dioxide nanorod prepared in accordance with an embodiment of the present invention;

FIG. 6 is an electron diffraction pattern of titanium dioxide nanorod prepared in accordance with an embodiment of the present invention;

FIG. 7 is an X-ray diffraction pattern of titanium dioxide nanorod prepared in accordance with an embodiment of the present invention; and

FIG. 8 is a scanning electron microscopic photograph of electrospun titanium dioxide fiber obtained by calcinations of titanium dioxide-polystyrene composite fiber at 450° C. for thirty minutes in accordance with comparison of the present invention.

### DETAILED DESCRIPTION OF THE INVENTION

Reference will now be made in detail to the preferred embodiments of the present invention, examples of which are illustrated in the accompanying drawings.

Hereinafter, a nanorod prepared using ultrafine titanium dioxide fiber and a nanorod preparation method according to the present invention will now be explained.

An embodiment according to the present invention used an electrospinning method as a method used for obtaining ultrafine fiber. Sol-gel precursor of metal oxides and appropriate polymer solution are mixed together to be used for the electrospinning. Here, the polymer is used to increase solution viscosity to thus form fiber when electrospinning the solution. A structure of electrospun fiber can be controlled by compatibility between the metal oxide precursor and polymer.

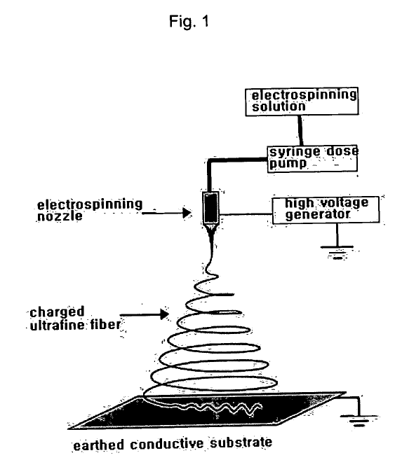

The electrospun metal oxide/polymer composite fiber accompanies with complicated formation processes in the internal structure of fiber. As can be seen in an electrospinning apparatus shown in FIG. 1, an electrospinning solution is injected through an electrospinning nozzle charged from a high voltage generator, and then fly toward an earthed conductive substrate by an electric field. Accordingly, a jet flow of the electrospinning solution is generated from the electrospinning nozzle to the earthed substrate. The jet flow under the high voltage electric field elperience whipping phenomenon which results in rapid decrease of jet diameter due to high stretching jet, the jet of polymer solution first reacts upon moisture in the air, and accordingly the metal oxide precursor is converted from a sol state into a gel state. Such sol-gel conversion and electrospinning result in rapid decrease of a fiber diameter and rapid increase in a surface area thereby. Accordingly, the solvent in the jet flow is rapidly volatilized. In this process, the concentration of the jet flow solution is sharply changed while the aforementioned chemical reaction occurs. As the solvent is volatilized, the temperature of a fiber surface is lowered. At this time, the moisture in the air is condensed, which differentiates the degree of the sol-gel conversion reaction. Especially, in the electrospinning from the metal oxide-polymer mixed solution, the hydrolysis reaction depends on the moisture. Accordingly, the temperature and humidity around the electrospinning apparatus act as important process variables.

The sol-gel reaction of the titanium dioxide precursor solution discharged through the electrospinning nozzle during the electrospinning occurs depending on the moisture. During the (preparation) of the electrospinning solution, the precursor is partially hydrolyzed, and accordingly is previously mixed with the solution as a titanium dioxide sol shape. Then, upon starting up the electrospinning, a gelation reaction is performed more rapidly. The jet flow of the electrospinning solution discharged while the gelation reaction is performed is rapidly thinning. Here, the surface area of the fiber is greatly increased to thus volatilize the solvent. A metal oxide precursor and the polymer solution which have thermodynamically been in the phase equilibrium state therewith start up their phase separation according to the rapid change in the concentration and the gelation reaction. The compatibility between the polymer and titanium dioxide precursor used in the process greatly influences on the structure of the electrospun fiber.

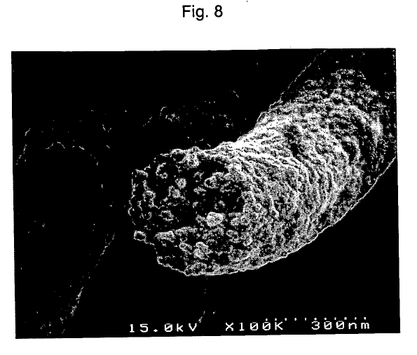

When a polymer, which is not well compatible with the metal oxide precursor and thus difficult to maintain a phase equilibrium therewith, namely, when polystryrene (PS) is used as matrix, a titanium dioxide domain is rapidly solidified. Accordingly, the titanium dioxide within the electrospun fiber can have a particle shape as shown in FIG. 8, and thus it may not be appropriate to generate a nanorod to be desirably prepared according to the present invention.

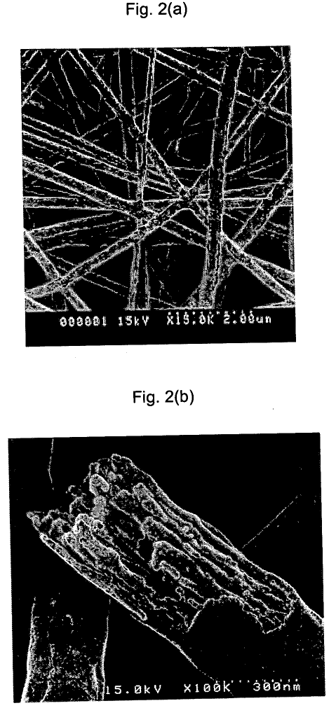

On the other hand, for a polymer having a superior compatibility, for example, poly(vinyl acetate) PVAc, the phase separation is performed slowly, and accordingly the titanium domain and the PVAc domain coexists with fluidity. Here, as the solvent is rapidly volatilized, the temperature of the fiber surface is lowered. Moisture around the fiber surface is condensed accordingly. As a result, the gelation reaction occurs differently within the fiber and at the surface thereof. When each domain has the fluidity, the domain is drawn during the electrospinning. Hence, a domain having a ultarfine fibril structure aligned in an axial direction of the fiber within the fiber as shown in FIG. 2b. Each fibril is formed to be approximately 15 nm thick.

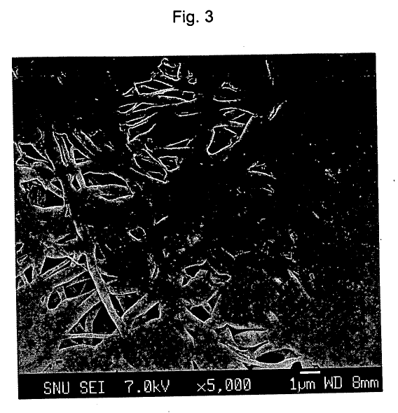

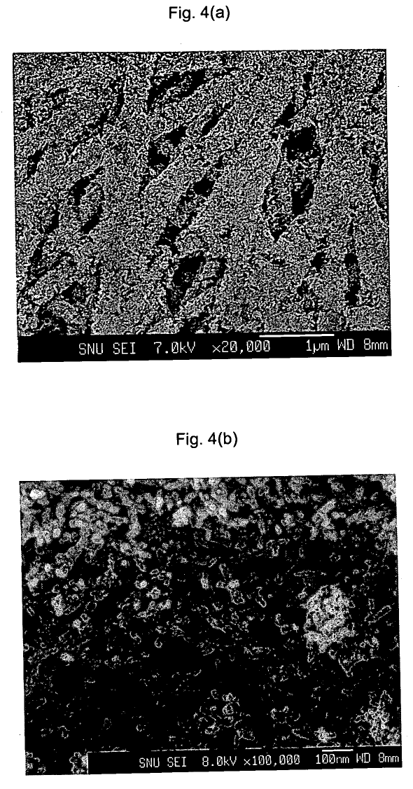

In the present invention, a ultrafine fibrous titanium dioxide structure is formed by the phase separation, and each fibril structure is changed into the nanorod by heat-pressing. The PVAc contained in the electrospun fiber is partially plasticized while heat-pressing it at a temperature of about 120° C. to thus form a coating film as shown in FIG. 3. At this time, the fiber is separated to form a nanorod aggregate. The formed nanorod aggregate is heat-treated at a temperature of about 450° C. to then remove the PVAc. Accordingly, there only remains the titanium nanorod. Scanning electron microscopic photos thereof can be seen in FIG. 4a (at magnification of 20,000) and FIG. 4b (at magnification of 100,000).

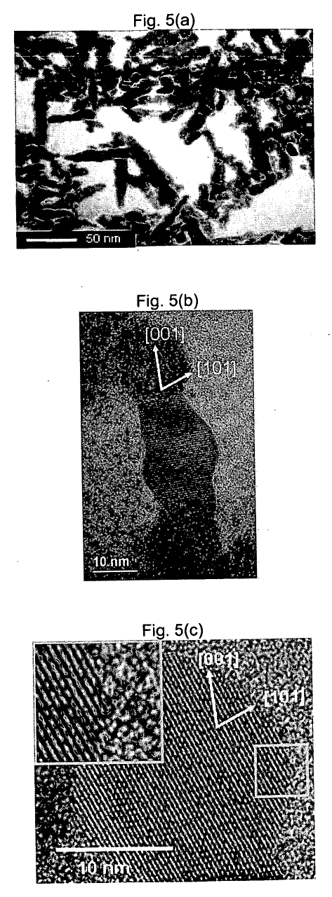

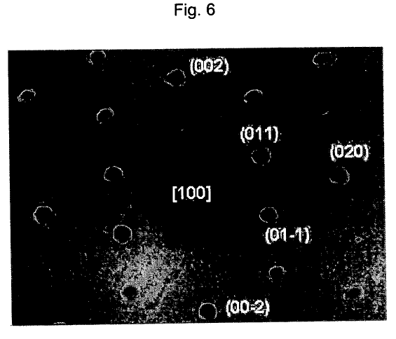

In order to analyze the fine structure of the prepared nanorods, the nanorods were detached from the substrate. A structure of an individual nanorod using the transparent electron microscope, which could be seen in FIG. 5a. The titanium dioxide nanorod prepared according to such method had a uniform thickness (diameter) of about 15 nm, and a length of 50 to 80 nm. The fine structure of the separated nanorod can be analyzed at ultra high magnification using a high resolution transmission electron microscopy (HRTEM), which can be noted in FIG. 5b. It could be confirmed, as shown in FIG. 5c, that a crystalline face uniformly grows in an axial direction of the nanorod. In particular, each nanorod was a single crystal titanium dioxide, as shown in FIG. 6, and grew in the axial direction of the crystal structure [001].

In more detail explanation of the present invention, first, an electrospinning solution is prepared using a sol-gel reaction of titanium (IV) propoxide as the titanium dioxide precursor. In detail, first, the PVAc having a high affinity for the titanium dioxide is dissolved in dimethylformamide, acetone, tetrahydrofuran, toluene, or a mixed solution thereof, etc. 5 to 20% by weight of polymer solution is prepared so as to form polymer solution with a viscosity appropriate for the electrospinning. The PVAc uses a polymer of which weight average molecular weight is 100,000 to 1,000,000 g/mol. The polymer solution can be prepared using poly vinyl pirrolidone, poly vinyl alcohol, polyethylenoxide, instead of the PVAc. Next, titanium isopropoxide having 5 to 25% to the PVAc polymer solution is added to the polymer solution, and acetic acid, as a catalyst , having 20 to 60% to titanium propoxide is added, reaction being performed in such polymer solution at a room temperature for 1 to 5 hours, which is then used as an electrospinning solution.

Thereafter, the electrospinning apparatus is used to obtain an electrospun ultrafine titanium dioxide fiber. As shown in FIG. 1, a typical electrospinning apparatus may include an electrospinning nozzle connected to a syringe pump by which the electrospinning solution is able to be injected quantitatively, high voltage generator, a conductive substrate for collecting an electrospun fibrous layer, and the like. Depending on purpose of usage thereof, an earthed metal plate, a transparent conductive glass substrate on which ITO or FTO is in detail coated, or a plastic substrate is used as a cathode, an electrospinning nozzle having a pump which adjusts a discharge amount per hour is used as an annode. 10 to 30 KV of voltage is applied and a solution discharge speed is adjusted by 10 to 50 μl/min. Accordingly, the ultrafine titanium dioxide fiber having a fiber diameter of 50 to 1000 nm can be prepared. The electrospinning is performed until the ultrafine titanium dioxide fiber mat is collected on the conductive substrate with a thickness of 5 to 20 μm.

The substrate on which the electrospun fiber is deposited is heat-pressed at a press with a pressure of 1.5 Ton at a temperature of 120° C. (in case of using the PVAc for pretreatment) or at a temperature more than a glass transition temperature of the used polymer for ten minutes. In this process, ultrafine fibril structure formed by the phase separation during the electrospinning is separated. After the heat-pressing process, the used polymer is d removed by a heat-treatment in the air at the temperature of 450° C. for 30 minutes, thereby obtaining the titanium dioxide nanorods which are formed as shown in FIGS. 4a and 4b. Here, during the heat-treatment, the titanium dioxide is crystallized as an anatase type, and the nanorod obtains a single crystalline shape. Each crystal uniformly grows in an axial direction thereof.

A metal substrate or a transparent conductive glass substrate coated with ITO or FTO, on which the titanium dioxide nanorods according to the present invention are stacked, can directly be used as an electrode substrates of solar cells or optical sensor using an electric signal, gas sensor, and the like.

In addition, upon crushing the titanium dioxide nanorod mat of the present invention using an appropriate way such as ultrasonic wave, titanium dioxide nanorod powders can be obtained. The titanium dioxide nanorod powders are used as an photocatalyst or mixed with an appropriate binder to be then coated on the glass substrate having the transparent conductivity coated with the ITO or FTO or a transparent plastic film such as PET for use. The method for preparing the ultrafine fiber from the titanium dioxide precursor according to the present invention is not limited on only the electrospinning. The present invention may also use any method for preparing an ultrafine fiber by which a titanium dioxide nanorod can be prepared using a phase separation in the process of electrospinning the titanium dioxide precursor solution. The method for preparing the ultrafine fibrous titanium dioxide precursor fiber for preparing the nanorods can use methods such as melt-blown, flash spinning, electrostatic-melt blown, and the like as well as the electrospinning.

### EXAMPLE 1

### Preparation of Ultrafine Titanium Dioxide Fiber Using Poly(Vinyl Acetate)

6 g of titanium propoxide was slowly added into a polymer solution in which 30 g of poly(vinyl acetate) (Mw 850,000) was dissolved in a mixed solvent of 270 ml of acetone and 30 ml of dimethylformamide. At this time, reaction therebetween was started by moisture contained in the solvent, and accordingly the polymer solution was changed into suspension. Next, 2.4 g of acetic acid was slowly dropped in the solution as a reaction catalyst. At this time, as the reaction was performed, the suspension was changed into a transparent solution.

The electrospinning apparatus as shown in FIG. 1 was used to perform the electrospinning. A transparent conductive substrate (a size of 10 cm×10 cm) coated with FTO was used as a cathode, and a metal needle having a pump for adjusting a discharge speed was used as an annode. 15 KV of voltage was applied between the cathode and the annode. The electrospun solution was discharged at a discharge speed of 30 μl/min until the total of the discharged amount was 5,000 μl. Accordingly, an ultrafine titanium dioxide-poly(vinyl acetate) composite fiber mat was deposited on the transparent conductive substrate coated with the FTO. A scanning electron microscopic photo of an ultrafine fiber stacked by the electrospinning according to this embodiment can be seen in FIG. 2a. Also, a scanning electron microscopic photo of a titanium dioxide fiber after removing the poly(vinyl acetate) by a heat-treatment at a temperature of 450° C. can be seen in FIG. 2b.

### COMPARATIVE EXAMPLE 1

### Preparation of Untrafine Titanium Dioxide Fiber Using Polystyrene

Polystylene (350,000 g/mol of molecular weight) was dissolved in DMF at a concentration of 0.25 g/mL to thereafter add the titanium propoxide thereto at a concentration of 0.19 g/mL. Then, a small amount of acetic acid was added thereto as a reaction catalyst to thus perform solation reaction of the titanium propoxide. Thereafter, the electrospinning was performed therefor using the same apparatus as used in the first embodiment. After the electrospinning, the titanium dioxide- polystylene composite fiber was heat-treated at a temperature of 450° C. to thereby remove the polystylene used as matrix. Accordingly, the titanium dioxide fiber structure was obtained, which could be seen in FIG. 8. Unlike in the first embodiment, the titanium dioxide does not have the fibril structure, in this comparing embodiment, but has a particle type. As a result, it was not appropriate to be used as fiber for preparing the nanorod according to the present invention.

### EXAMPLE 2

### Nanorod Preparation By Pretreatment and Heat-Treatment of Substrate Having Thereon Titanium Dioxide Fibrous Layer Prepared in Example 1

The titanium dioxide fibrous layer prepared in first embodiment is mixed with polymer and titanium dioxide. Accordingly, in order to prepare the nanorods according to the present invention, the substrate on which polymer-titanium dioxide composite fiber was stacked was pressed at a press heated by a temperature of 140° C. with pressure of 1.5 Ton for ten minutes, thereby separating the fibrous titanium dioxide formed by the electrospinning therefrom. After being pressed, a plasticized poly(vinyl acetate) is partially changed at the surface of the fiber, as shown in FIG. 3, to thus form a coating film.

The substrate heat-pressed according to the method is then heat-treated at a temperature of 450° C., and thus the contained poly(vinyl acetate) is completely removed from the substrate by a heat-decomposition, and the formed titanium dioxide nanorod is crystallized. A scanning electron microscopic photo of the surface of the titanium dioxide after being heat-treated according to the first and second embodiments at magnification of 20,000 can be seen in FIG. 4a. A scanning electron microscopic photo thereof at magnification of 100,000 can be seen in FIG. 4b. As can be seen in FIG. 4b, it can be noted that the titanium dioxide was well formed in a titanium dioxide nanorod aggregate after being heat-treated.

### EXAMPLE 3

### Preparation of Titanium Dioxide Nanorod Powder

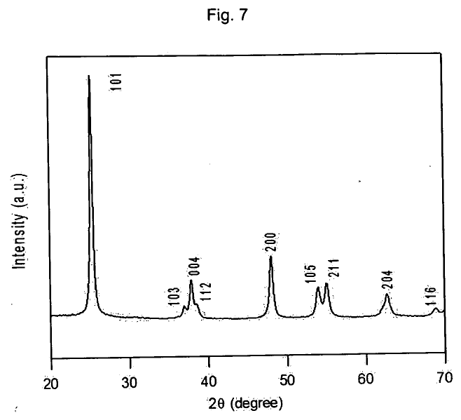

The sheet formed on the electrodes, as the titanium dioxide nanorod aggregate prepared in the second embodiment, is separated to be mixed with ethanol, to which ultrasonic wave is applied to thus be divided into individual titanium dioxide nanorod, thereby obtaining nanorod powders. The nanorod powder can be obtained by precipitating solids at a centrifuge and removing the ethanol according to a condensation drying method. It can be confirmed from the high resolution transmission electron microscopic photos (FIGS. 5a through 5c) and the electron diffraction photo (FIG. 6) that the titanium dioxide nanorod prepared in the embodiment has a single crystal shape with a width of about 15 nm and a length of 50 to 80 nm. Also, as shown in FIG. 7, it could be noted through an X-ray diffraction that the nanorod crystal has the anatase type.

As described above, the titanium dioxide nanorod according to the present invention can be formed on the electrode substrate to be applied directly thereto, and can also advantageously be divided into nanorods to thus be used as anisotropic particles. The nanorod formed on the substrate has a high great surface area to thus be able to be directly used as a substrate of dye-sensitized solar cells or optical sensors using an electric signal, gas sensor and the like. The nanorod can also be used as a photocatalyst.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. Preparation method of Titanium dioxide nanorod comprising:
preparing a mixed solution containing a titanium dioxide precursor, a polymer which is compatible with the precursor and solvent;
spinning the mixed solution to form a titanium dioxide polymer composite fiber containing ultrafine fibril structure formed therein by a phase separation between the titanium dioxide precursor and the polymer;
heat-pressing the composite fiber; and
removing the polymer material from the composite fiber to obtain titanium dioxide nanorods.

2. The method of claim 1, wherein the spinning of the mixed solution is carried out using an electrospinning device.

3. The method of claim 2, wherein the composite fiber is deposited on an earthed metal plate, a transparent conductive glass substrate coated with a ITO or FTO or a transparent plastic substrate.

4. The method of claim 1, wherein the ultrafine fibril is aligned in an axial direction of the composite fiber.

5. The method of claim 1, wherein the titanium dioxide nanorod has a single crystal structure.

6. The method of claim 1, wherein the polymer is one of poly(vinyl acetate), Poly (vinylpyrroli done), and polyethylene oxide.

7. The method of claim 1, wherein the heat-pressing process is performed by applying pressure over a glass transition temperature of the polymer.

8. The method of claim 1, wherein the mixed solution is electrospun using methods such as melt-blown, flash spinning, or electrostatic-melt blown.

9. A single crystal titanium dioxide nanorod prepared according to the method of claim 1.

10. A dye-sensitized solar cell using a metal plate, a transparent conductive glass substrate coated with ITO or FTO or a plastic substrate, on which a titanium dioxide nanorod aggregate prepared according to the method of claim 1 is formed.

11. A sensor using a metal plate having thereon a titanium dioxide nanorod aggregate prepared according to the method of claim 1, a transparent conductive glass substrate coated with ITO or FTO, or a plastic substrate.

12. A photocatalyst using a single crystal titanium dioxide nanorod prepared according to the method of claim 1.
